(19) United States
(12) Patent Application Publication
(10) Pub. No.: US 2019/0129112 A1
(43) Pub. Date: May 2, 2019

(54) LASER MODULE SYSTEM AND PLUGGABLE LASER MODULE FOR OPTICAL TELECOMMUNICATIONS SWITCHING APPARATUS

(71) Applicant: CORNING OPTICAL COMMUNICATIONS LLC, Hickory, NC (US)

(72) Inventor: Andreas Matiss, Berlin (DE)

(21) Appl. No.: 16/156,376

(22) Filed: Oct. 10, 2018

Related U.S. Application Data
(60) Provisional application No. 62/579,510, filed on Oct. 31, 2017.

(51) Int. Cl. G02B 6/42; H04B 10/50

(52) U.S. Cl. CPC G02B 6/4278; H04B 10/503; G02B 6/4292; G02B 6/426

(57) ABSTRACT

The laser module system for use with an optical telecommunications apparatus has a laser module having first and second ferrules, a first harness with first optical waveguides that optically connect the first ferrule to the second ferrule, a laser assembly that generates laser light beams having different wavelengths, and a second harness with second optical waveguides that optically connect the laser assembly to the second ferrule. A third harness with third optical waveguides resides within the apparatus. An O-E adapter also resides within the apparatus. The O-E adapter receives the second and third ferrules and places the first and second optical waveguides of the first and second harnesses in optical communication with the third optical waveguides of the third harness. The laser module can be plugged into and unplugged from the receptacle.

### PRIORITY APPLICATION

This application claims the benefit of U.S. Provisional Application No. 62/579,510, filed on Oct. 31, 2017, the content of which is relied upon and incorporated herein by reference in its entirety.

### FIELD

The present disclosure relates to optical telecommunications apparatus, and in particular relates to a laser module system and a pluggable laser module for an optical telecommunications switching apparatus.

### BACKGROUND

Optical telecommunication systems are used for transmitting optical data signals to and from a data center. This requires optical-to-electrical apparatus to convert the optical data signals to electrical data signals and vice versa, and switching apparatus for switching the electrical data signals for routing to their intended downstream destinations.

Current switching apparatus utilizes fully electronic application-specific integrated circuits (ASICs) to perform the switching of the electrical data signals. Current state-of-the-art ASICs technology offers about 3.2 Terabit per second (Tbps) total switching bandwidth. To make this switching capacity accessible, the ASIC is packaged and mounted on a printed circuit board (PCB) that makes up the switching apparatus, which can reside as a blade within a standard optical telecommunications apparatus rack. The ASIC package includes electrical input and output (I/O) ports (e.g., a ball grid array (BGA)) that are electrically contacted to electrical contacts on the PCB. The PCB electrical contacts are in turned routed to a front plate of the switching apparatus. The front plate includes receptacle housings for so called pluggable modules that include the O-E conversion apparatus that converts the outgoing electrical data signals into outgoing optical data signals for extended reach data transmission.

Unfortunately, the space on the front plate is limited so that only a limited number of pluggable O-E devices can be accommodated. In addition, it is known that electrical data transmission degrades with increased line rate and requires more advanced materials or compensation techniques to equalize. Furthermore, the ASICs switching bandwidth will eventually exceed the transmitting capability of the electrical input/output (I/O) of the ASIC packaging.

The O-E devices utilize laser sources for generating the optical signals. Unfortunately, the laser sources (e.g., distributed feedback (DFB) lasers) experience reduced reliability in high-temperature environments. In addition, if a laser source fails, the present configuration for the switching apparatus that has the O-E convertor integrated with the ASIC package requires shutting down the switching apparatus, removing the entire PCB (blade), and sending it out just to repair the failed laser.

### SUMMARY

Aspects of the disclosure relate to a differentiated optical-waveguide-based apparatus interconnect architecture wherein the lasers are disaggregated from the O-E devices and form part of a pluggable laser module that can be received by a receptacle at in the front plate of the apparatus. This allows for hot-pluggable and easy replacement of a failed laser in the system. This contrasts with prior art systems where the lasers are integrated deep into a main printed circuit board and are not readily accessible.

The laser module disclosed herein is described with respect to its role in a WDM system. The laser module can remain in the receptacle at the front plate of the apparatus for easy accessibility. The laser module has first and second optical coupling interfaces and an electrical coupling interface. The first and second optical coupling interfaces are defined at least in part by first and second ferrules. The laser module includes a laser assembly that houses the lasers, which would otherwise be located deep in the system. The first optical coupling interface is accessible from the outside and can connect to an external cable that supports transmit and receive optical waveguides (e.g., optical fibers). The other optical coupling interface is accessed via the front-plate receptacle and optically connects the lasers of the laser module to an internal optical waveguide harness using an O-E adapter. The second optical coupling interface also optically connects the transmit and receive optical waveguides of the cable to the optical waveguides of the harness. The electrical coupling interface is used as a relatively low speed management and control interface to set laser parameters and for performance monitoring, and can also provide electrical power to the laser module. The harness optically connects the laser module with an O-E device, which can be either on a main circuit board (e.g., a main PCB) or supported on or in the ASIC.

An embodiment of the disclosure includes a laser module for plugging into and unplugging from a receptacle in an optical telecommunications switching apparatus. The laser module comprises: a module housing comprising a first end, a second end and an interior; a first ferrule supported at the first end of the module housing and a second ferrule supported at the second end of the module housing; first optical waveguides that reside in the module housing interior and that optically connect the first ferrule to the second ferrule; a laser assembly that resides at least partially disposed within the interior of the module housing and that emits laser light beams comprising a plurality of different wavelengths; and second optical waveguides that reside in the module housing interior and that optically connect the laser assembly to the second ferrule.

Another embodiment of the disclosure includes laser module for a laser module system. The laser module comprises: a first circuit board comprising a first-end section with a first end, a second-end section with a second end, and first and second opposite sides, wherein at least the second-end section comprises electrical features; a laser unit operably supported at the first-end section of the first circuit board, the laser unit comprising a plurality of lasers optically coupled to at least one multiplexer, with the plurality of lasers configured for emitting respective laser beams comprising a plurality of different wavelengths; a first optical waveguide harness comprising first optical waveguides comprising first ends supported by a first ferrule operably disposed adjacent the first end of the first circuit board and second ends supported by a second ferrule adjacent the second end of the first circuit board; and a second optical waveguide harness comprising second optical waveguides comprising first ends optically coupled to the at least one multiplexer of the laser unit and second ends operably supported by the second ferrule.

Another embodiment of the disclosure includes a pluggable laser module for plugging into and unplugging from a receptacle of an optical telecommunications switching apparatus. The pluggable laser module comprises: a module housing having first and second opposite ends and an interior and sized to fit within the receptacle; a first circuit board comprising a first-end section with a first and, a second-end section with a second end, wherein the first-end section is disposed within the interior of the module housing and wherein the second-end section comprises first electrical features and extends from the second end of the module housing; a laser unit operably supported on the first-end section of the first circuit board and comprising a plurality of lasers that respectively emit laser light beams comprising a plurality of different wavelengths, and at least one multiplexer comprising an input end and an output end, with the input end optically coupled to the plurality of lasers; first optical fibers comprising first ends supported by a first ferrule at the first end of the module housing and comprising second ends supported at the second end of the module housing by a second ferrule; second optical fibers comprising first ends optically coupled to the multiplexer of the laser assembly and comprising second ends supported by the second ferrule at the second optical coupling interface; and a second circuit board comprising a first-end section with a first end, a second-end section with a second end and second electrical features, wherein modular housing is supported by the second-end section of the second circuit board.

Another embodiment of the disclosure includes a laser module system for use with an optical telecommunications switching apparatus comprising a receptacle with an interior having an interior end. The laser module system comprises: a laser module comprising: i) first and second ferrules; ii) a first harness defined by first optical waveguides that optically connect the first ferrule to the second ferrule; iii) a laser assembly configured for generating laser light beams comprising a plurality of different wavelengths; and iv) a second harness defined by second optical waveguides that optically connect the laser assembly to the second ferrule; a third harness defined by third optical waveguides terminated by third and fourth ferrules, the third harness residing within the optical telecommunications switching apparatus; and an optical-electrical (O-E) adapter that resides within the optical telecommunications switching apparatus at the interior end of the receptacle and configured for receiving the second and third ferrules and place the first and second optical waveguides of the first and second harnesses in optical communication with the third optical waveguides of the third harness.

Another embodiment of the disclosure includes a method of forming multiplexed optical signals. The method comprises: generating unmodulated laser light beams having different wavelengths using lasers that are disposed in an interior of a module housing comprising first and second ends, with the first end defining a first optical coupling interface; transmitting the unmodulated laser light beams to an O-E device in a first direction through a second optical coupling interface defined by an O-E adapter, wherein the O-E adapter and the O-E device is disposed outside of the module housing; using the O-E device, forming optical signals from the unmodulated laser light beams, wherein the optical signals respectively comprise the different wavelengths; and sending the optical signals from the O-E device to the first optical coupling interface by passing the optical signals through the second optical coupling interface in a second direction opposite the first direction and through the interior of the module housing.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a schematic diagram of a conventional CWDM optical communications system;

FIGS. 2A and 2B are top-down views of an example of a laser module system as disclosed herein;

FIG. 2C is a side view of an example of the example laser module system of FIGS. 2A and 2B;

FIG. 2D is a close-up view of an example laser module of the laser module system disclosed herein;

FIG. 2E is a close-up view of the laser assembly of the laser module of FIG. 2D;

FIG. 3 is a close-up cross-sectional view of an example O-E adapter illustrating the second optical coupling interface and the electrical coupling interface;

FIG. 4A is a schematic diagram of a transceiver of an example CWDM system that employs the laser module system and pluggable laser module disclosed herein;

FIG. 4B is a schematic diagram of an example CWDM system that includes first and second transceivers and first and second laser module systems as disclosed herein;

FIG. 5 is a schematic diagram illustrating the use of multiple transceivers on each side of the CWDM system; and

FIG. 6 is a schematic diagram that shows multiple pluggable laser modules and their corresponding optical communication links to 256 channels of the ASIC of the laser module system.

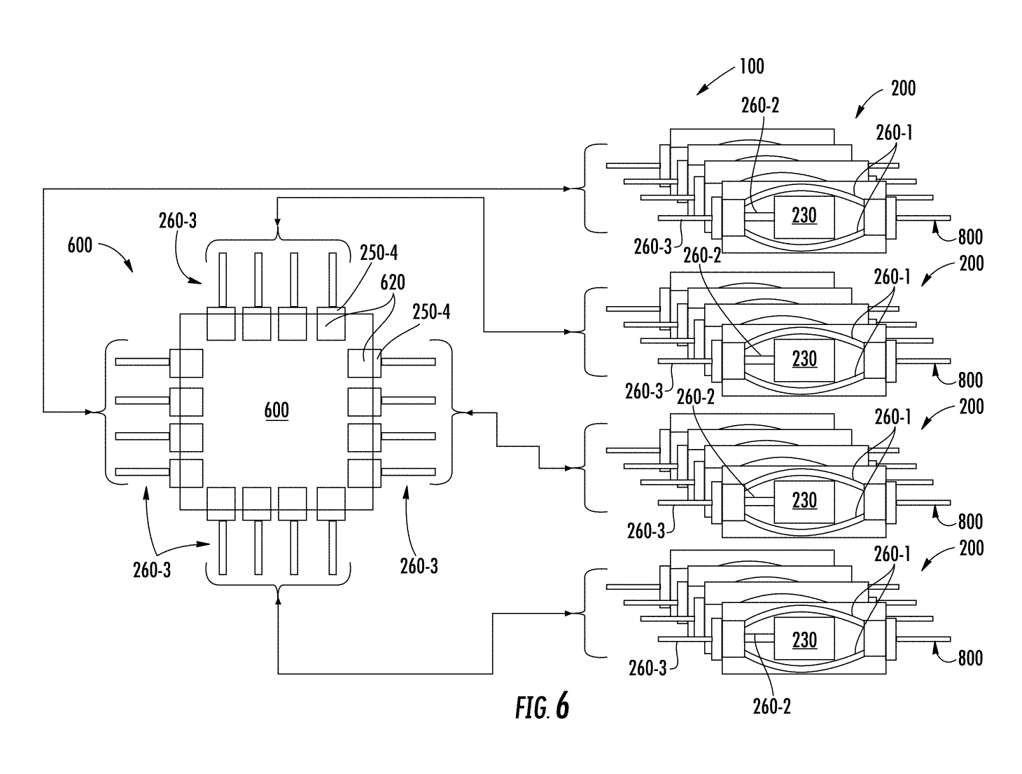

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

The term “pluggable” as used herein with respect to the laser module and to the receptacle of an optical telecommunications switching apparatus means that the laser module can be plugged into (i.e., operably inserted into) and unplugged from (operably removed from) the receptacle.

The term “O-E device” as used herein describes a unit configured to convert optical to electrical signals and also convert electrical signals to optical signals. The O-E device can reside separate from the ASIC (introduced and described below), and be electrically connected thereto (e.g., by residing on a common printed circuit board), or can be incorporated into a single IC chip that combines the ASIC and the O-E device. The O-E device is configured to receive electrical signals from the ASIC and use the electrical signals to form modulated optical signals from an unmodulated optical beam provided to the O-E device.

The term “O-E adapter” as used herein describes a module configured to facilitate establishing an optical interconnection and an electrical interconnection between two apparatus each having optical and electrical communication functionality. The O-E adapter can thus be said to define at least in part an optical coupling interface and an electrical coupling interface.

The term “optical coupling interface” means a location where optical coupling of light can occur either between first and second optical waveguides or between a first waveguide and an optical device, such as the O-E device, discussed below. It is understood that light can travel in first and second opposite directions through a given optical coupling interface. In examples discussed below, an optical coupling interface can be defined at least in part by a ferrule that supports ends of optical waveguides. In another example, the “second” optical coupling interface described below is defined in part by an O-E adapter that places second and third ferrules in a confronting arrangement so that the optical waveguides respectively supported therein are optically coupled, i.e., are in optical communication.

The term “electrical coupling interface” as used herein refers to a location where electrical coupling of electrical signals can occur between electrical contacts of two apparatuses each having electrical functionality.

Relative terms like “front,” “back,” “top,” “bottom,” etc., are used herein for ease of discussion and explanation and are not intended to be limiting as to direction or orientation.

Conventional CWDM System

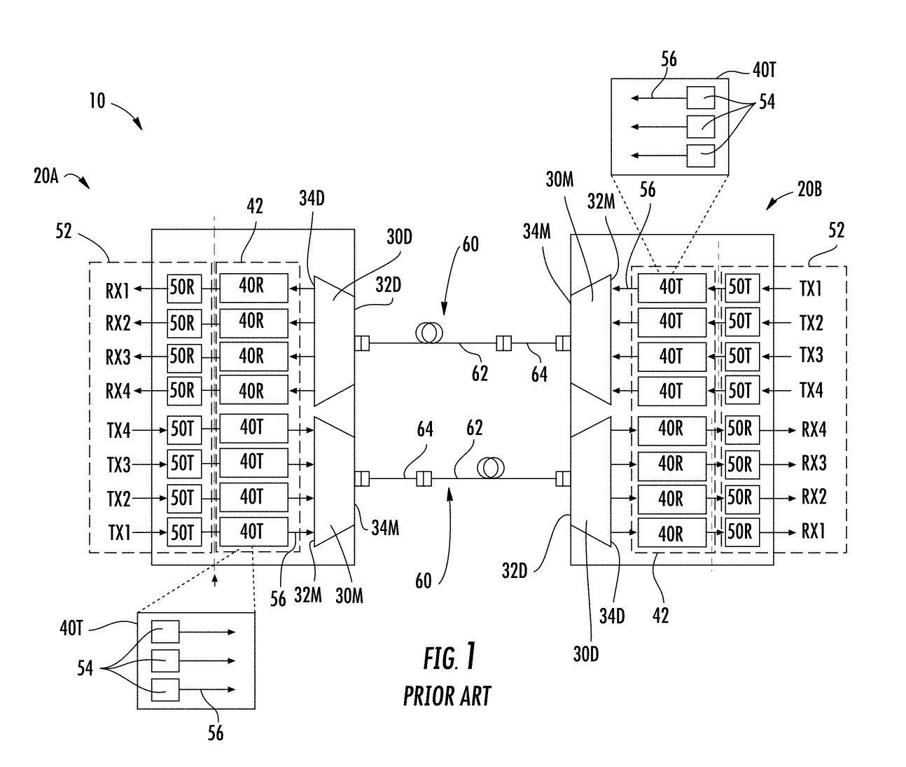

FIG. 1 is a schematic diagram of a conventional coarse wavelength-division multiplexing (CWDM) optical communications system (“CWDM system”) 10. The CWDM system 10 includes two transceiver units 20A and 20B. Each transceiver unit 20A and 20B includes a WDM multiplexer (“multiplexer”) 30M having an input end 32M and an output end 34M, and a WDM demultiplexer (“demultiplexer”) 30D having an input end 32D and an output end 34D. The demultiplexer is optically connected at its output end 34D to an array of optical receivers 40R, each of which is electrically connected to a corresponding receiver retimer 50R. Likewise, the input end 32M of the multiplexer 30M is optically connected to an array of optical transmitters 40T, each of which is electrically connected to a transmitter retimer 50T.

The transceiver units 20A and 20B are optically connected by first and second optical fiber links 60 that each include a length of optical fiber cable 62 and a patch cord 64. Each of the transceiver units 20A and 20B is shown processing transmit signals TX1 through TX4 provided to the transmit retimers 50T and receive signals RX1 through RX4 that are emitted from the receive retimers 50R. The optical receivers 40T constitute an O-E device 42 while the transmit and receive timers 50T and 50R are part of a switch 52.

As shown in the close-up insets, the optical transmitters 50T each include at least one laser 54. As noted above, these lasers are buried within the transceiver units 20A and 20B and repairing a defective laser 54 would require removal of the entire transceiver unit in which the defective laser was located.

Laser Module System

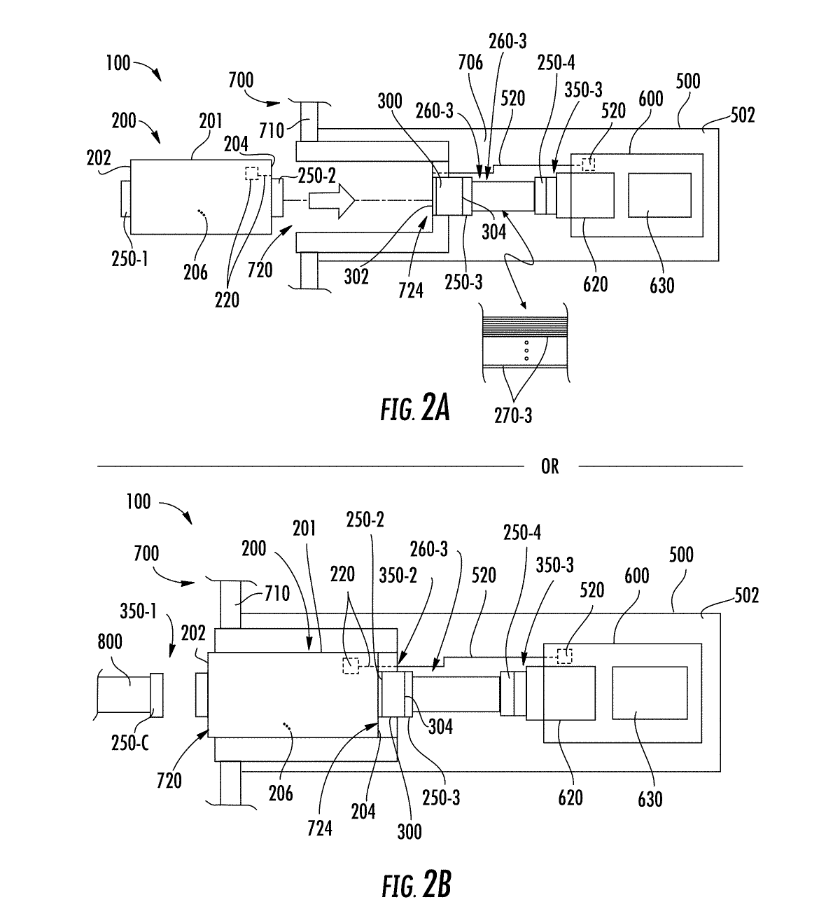

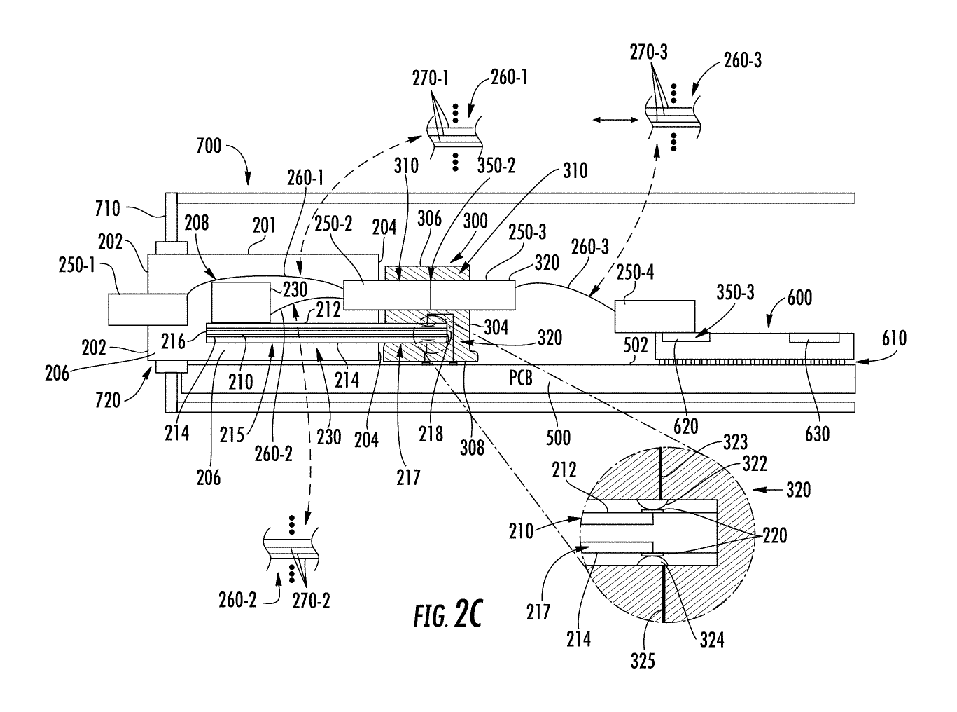

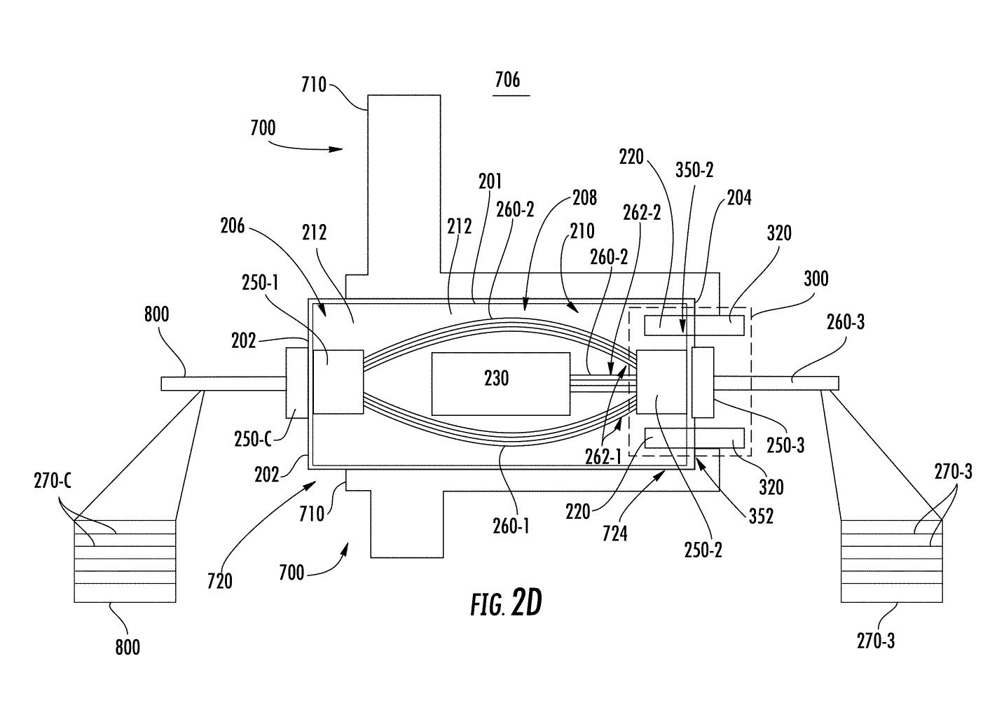

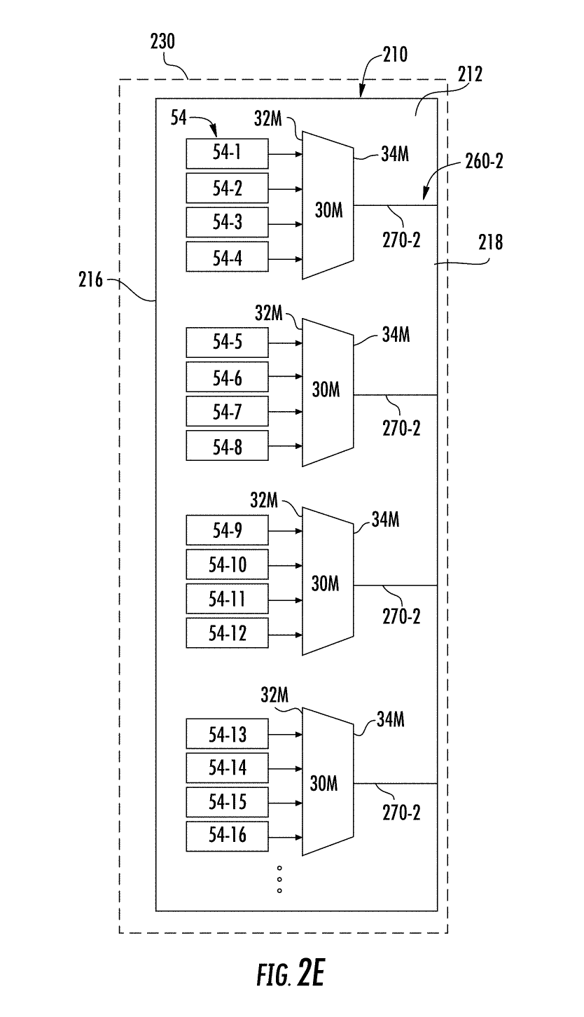

FIGS. 2A and 2B are top-down views and FIG. 2C is a side view of an example of a pluggable laser module system (“system”) 100 as disclosed herein. The main components of the system 100 include a pluggable laser module (“laser module”) 200, a hybrid electrical-optical (O-E) adapter 300, an optical waveguide harness 260-3 (also referred to as the “third harness” or the “main harness”), a main printed circuit board (PCB) 500 and an ASIC 600.

The system 100 is shown incorporated into an optical telecommunications switching apparatus 700 that includes an interior 706 and front plate 710 having a receptacle 720 with an back or “interior” end 724. The O-E adapter 300 and the third or main harness 260-3 are shown disposed in the interior 706 of the optical telecommunications switching apparatus 700 adjacent the interior end 724 of the receptacle 720.

FIG. 2A shows the laser module 200 in the process of being inserted into the receptacle 720 of the apparatus 700 while FIG. 2B shows the laser module operably arranged in the receptacle. FIG. 2B also shows an external optical waveguide cable (“cable”) 800 in the process of being optically connected to the laser module 200. The cable 800 includes optical waveguides (“cable optical waveguides”) 270-C supported at an end of the cable by a cable ferrule 250-C. In an example, the cable optical waveguides 270-C can comprise transmit and receive optical fibers. The cable ferrule 250-C can be part of an optical waveguide connector (not shown).

1. Laser Module

FIG. 2D is a close-up view of an example laser module 200. With reference to FIGS. 2A through 2D, the laser module 200 includes a module housing 201 having a front end 202, a back end 204, and an interior 206.

The laser module 200 includes a laser assembly 208, which comprises a PCB 210 and a laser unit 230 operably supported by the PCB. The PCB 210 has a top side 212, a bottom side 214, a front-end section 215 with a front end 216 and a back-end section 217 with a back end 218. The PCB 210 includes electrical features 220, such as conducting lines, contact pads, vias, etc., as is conventional in the art. In FIG. 2C, the electrical features 220 are shown in the form of contact pads and electrical lines on the top and bottom sides 212 and 214 in the back-end section 217. These and other of the electrical features 220 can be located in different sections of the PCB 210 and can run various distances and in different directions over and through the PCB, and only portions of the electrical features are shown for ease of illustration. In an example, the PCB 210 resides at least partially within the interior 206 of the module housing 200. In example, the back-end section 217 of the PCB 210 extends from the back end 204 of the module housing 200, as shown in FIG. 2C.

The laser unit 230 is operably supported at the front-end section 215 of the PCB 210. FIG. 2E is a close-up view of an example laser unit 230. The laser unit 230 includes two or more lasers 54 optically coupled to the input end 32M of one or more multiplexers 30M. In an example, the optical coupling is accomplished using optical fiber sections (not shown). FIG. 2E shows an example laser unit 230 that includes a total of 16 lasers 54 in four sets of four lasers 54, with each set of lasers optically coupled to a separate multiplexer 30M. The sixteen lasers 54 respectively emit laser light beams 56 having different wavelengths, e.g., λ1 through λ16. Or, each set of four lasers 54 will have identical wavelengths λ1 through λ4 respectively λ1, λ2, . . . have a wavelength spacing (i.e., a wavelength interval between adjacent wavelengths) of about 20 nm. The laser light beams 56 emitted from the lasers 54 represents DC light beams, i.e., the laser light beams are not modulated. In an example, the lasers 54 comprise distributed-feedback (DFB) lasers. The laser unit 230 can include as few as two lasers 54 and can also include more lasers than just 16 lasers, with the actual number of lasers depending on the number of wavelength channels used in system 10. The laser unit 230 is electrically contacted to the PCB 210 via the electrical features 220 on the PCB and corresponding electrical features (not shown) on the laser unit.

With particular reference to FIGS. 2A through 2D, the laser module 200 also includes first and second ferrules 250-1 and 250-2 each having an input end 252 and an output end 254. In an example, the first ferrule 250-1 is supported by the front end 202 of the module housing 201, with the back end 252 residing within the interior 206 of the module housing and adjacent the front end 216 of the PCB 210. Also in an example, the second ferrule 250-2 is supported at the back end 204 of the module housing 201, with the input end 252 residing within the interior 206 of the module housing. In FIG. 2C, the second ferrule 250-2 is shown residing above the back-end section 217 of the PCB 210, with the output end 254 of the second ferrule 250-2 residing substantially in the same plane as the back end 218 of the PCB. The first and second ferrules 250-1 and 250-2 respectively define first and second optical coupling interfaces 350-1 and 350-2. The first and second ferules 250-1 and 250-1 can be part of respective first and second connectors, which are not shown for ease of illustration.

The laser module 200 also includes a first harness 260-1 comprising first optical waveguides 270-1 having input ends 272 supported by the first ferrule 250-1 and also having output ends 274 supported by the second ferrule 250-2. The laser module 200 also includes a second harness 270-2 comprising second optical waveguides 270-2 having input ends 272 optically coupled to the output end 34M of the multiplexer(s) 30M of the laser unit 230 and output ends 274 supported by the second ferrule 250-2. Thus, the first ferrule 250-1 supports a number P of the first optical waveguides 270-1 while the second ferrule 250-2 supports the P first optical waveguides 270-1 and a number Q of the second optical waveguides 270-2. In other words, the first and second harnesses 260-1 and 260-2 share the second ferrule 250-2 at their respective output ends 262. The second harness 260-2 can also include a ferrule (not shown) that operably supports the first ends of the optical waveguides 270-2 and that operably engages the output end(s) 34M of the multiplexer(s) 30M.

Thus, for example, the first ferrule 250-1 can be configured to support P=8 first optical waveguides 270-1 while the second ferrule 250-2 can be configured to support 12 total optical waveguides; namely the P=8 first optical waveguides 270-1 and Q=4 second optical waveguides 270-2. In an example, the first and second optical waveguides 270-1 and 270-2 comprise first and second optical fibers. Also in an example, the first and second ferrules 250-1 and 250-2 comprise standard MPO ferules used in MPO multifiber connectors.

2. O-E Adapter

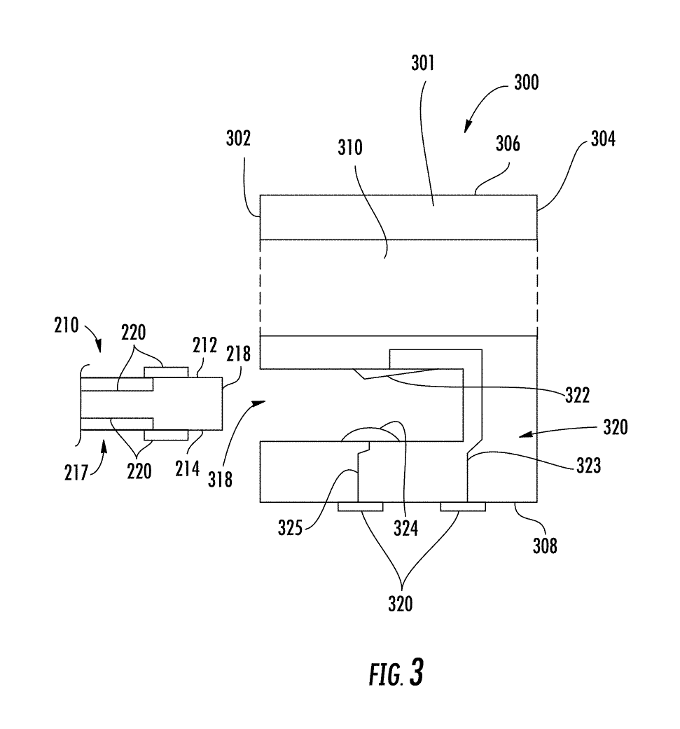

As noted above, the system 100 includes an O-E adapter 300. FIG. 3 is a cross-sectional view of an example O-E adapter 300. The O-E adapter 300 has a body 301 with a front end 302, a back end 304, a top 306 and a bottom 308. In an example, the O-E adapter resides in the interior of the optical telecommunications switching apparatus 700 at the interior end 724 of the receptacle 720.

A channel 310 runs in the z-direction between the front and back ends. The channel 310 serves a receptacle or sleeve for operably engaging two ferrules 250 from the front and back ends 302 and 304. In particular, with reference to FIG. 2C, the second ferrule 250-2 is shown engaged in the channel 310 from the front end 302 while a third ferrule 250-3, discussed in greater detail below, is shown engaged in the channel from the back end 304. In this arrangement, the respective front ends 252 of the ferrules 250-2 and 250-3 confront each other and are in close proximity or in operably contact. This defines the aforementioned second optical coupling interface 350-2, where the first and second optical waveguides 270-1 and 270-2 of the first and second harnesses 260-1 and 260-2 are optically coupled to the third optical waveguides 270-3 of the third or main harness 260-3.

In an example, the O-E adapter 300 also includes a slot 318 in the front end 302 sized to accommodate the back-end section 217 of the PCB 210. The O-E adapter also includes electrical features 320, including in the slot 318 an upper electrical contact 322 electrically connected to an upper wire 323 and a lower electrical contact 324 electrically connected to a lower wire 325. The upper and lower wires 323 and 325 each run through the O-E adapter body 301 to the bottom 308 and make contact with corresponding electrical features 520 in the form of electrical contacts on a top surface 502 of the main PCB 500. The main PCB 500 includes additional electrical features 520 in the form of wires (conducting lines) that provide electrical connection to the ASIC 600 and/or to other components supported on the main PCB, such as a power supply (not shown). Thus, the electrical connections between the PCB 210, the O-E adapter 300 and the main PCB 500 facilitated by the electrical features 220, 320 and 520 of the (first) PCB 210, the O-E adapter 300 and the second or main PCB 500 respectively, define an electrical coupling interface 352 that allows for electrical power and electrical control signals to be communicated between the main PCB and the laser unit 230, as described below.

3. Main Harness

With reference again to FIGS. 2A through 2C, the third or main harness 260-3 comprises one or more optical waveguides 270-3 having front ends 272 and back ends 274. The front ends 272 of the optical waveguides 270-3 are operably supported by the aforementioned third ferrule 250-3 while the back ends 274 are operably supported by a fourth ferrule 250-4. The third and fourth ferrules 250-3 and 250-4 can be considered part of the third or main harness 260-3.

As mentioned above, the third ferrule 250-3 is operably supported in the channel 310 of the O-E adapter at the back end 304. In this configuration, the optical waveguides 270-3 of the harness 260-3 are in optical communication with the optical waveguides 270-1 and 270-2 supported at their respective back ends 274 by the second ferrule 250-2 operably supported in the channel 310 at the front end 302 of the O-E adapter 300. The fourth ferrule 250-4 is operably supported on the ASIC 600, as described below. In an example, the optical waveguides 270-3 comprise optical fibers. In another example, the optical waveguides 270-3 define a ribbon cable (e.g., an optical fiber ribbon cable) that in an example can include a protective cover (not shown). In an example, the third or main harness 260-3 resides within the optical telecommunications switching apparatus 700.

4. ASIC

With continuing reference to FIGS. 2A through 2C, the ASIC 600 is operably supported on the top surface 502 of the PCB main 500. The ASIC 600 has a front-end section 601 with a front end 602, a back-end section 603 with a back end 604, a top surface 606 and a bottom surface 608. In an example, the bottom surface 608 includes electrical contacts 610 configured to make electrical contact with corresponding electrical features 520 in the form of electrical contacts on the top surface 502 of the main PCB 500. In an example, the electrical contacts 610 comprise solder balls of the type used in a flip-chip packaging and mounting configuration.

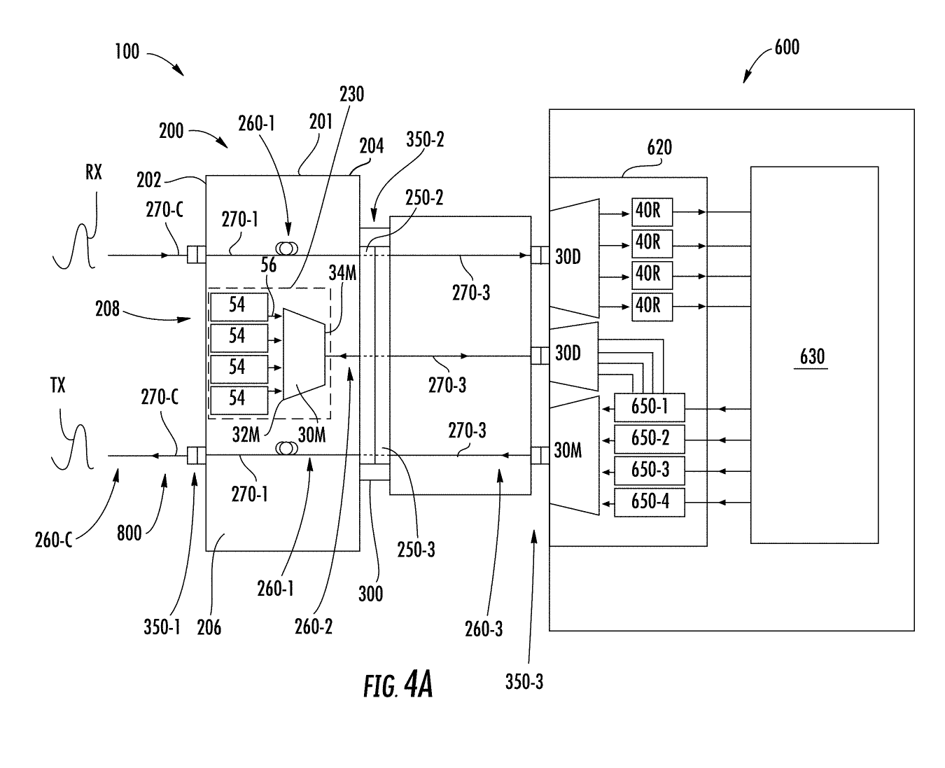

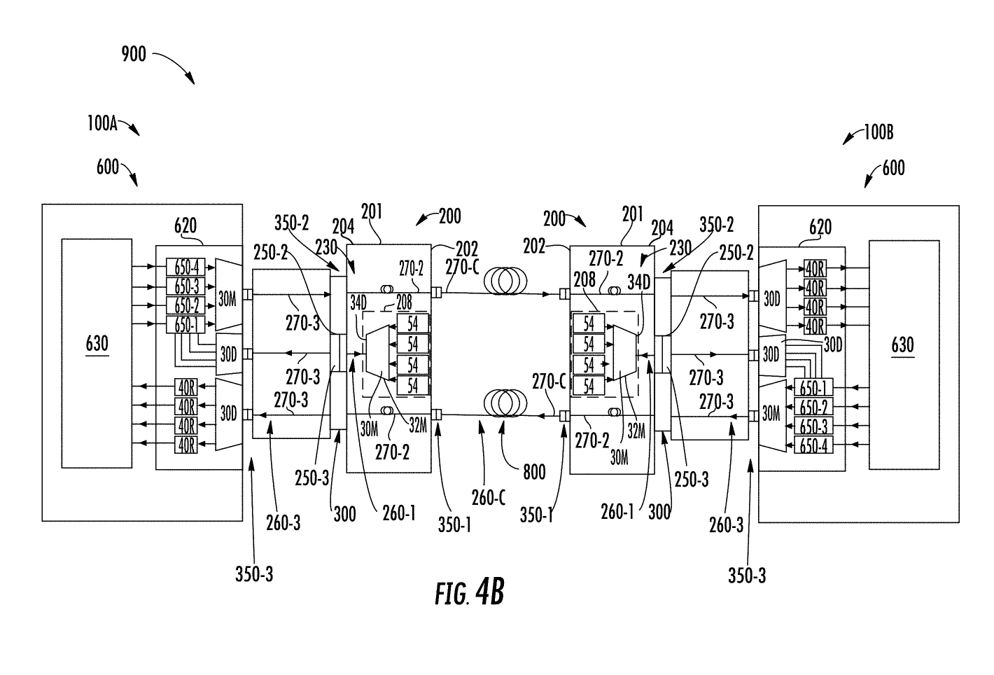

In an example, the ASIC 600 includes a O-E device 620 located at the front-end section 601 of the ASIC. In this configuration, the fourth ferrule 250-4 is operably arranged relative to the O-E device 620 so that the optical waveguides 270-3 are in optical communication with the O-E device to define a third optical coupling interface 350-3. In this third optical coupling interface 350-3, the optical coupling is between the third optical waveguides 270-3 and at least one optical component in the O-E device 620 (see FIG. 4, introduced and discussed below). Also in an example, the ASIC 600 includes a switching unit 630.

Method of Operation

FIG. 4A is a schematic diagram of the system 100 that helps explain the operation of the pluggable laser module 200. The system 100 shown in FIG. 4A defines a transceiver that can be used to form a CDWM system 900 according to the disclosure and as described below.

With reference first to FIGS. 2A through 2C, the laser module 200 is inserted into (i.e., plugged into) the receptacle 720 in the front plate 710 of the apparatus 700. This insertion process causes the second ferrule 250-2 to reside within the channel 310 at the front end 302 of the O-E adapter 300 so that the front end 252 of the second ferrule confronts the front end of the third ferrule 250-3, which resides in the channel at the back end 304 of the O-E adapter. This in turn places the first and second optical waveguides 270-1 and 270-2 of the laser module 200 in optical communication with the third optical waveguides 270-3 of the main harness 260-3 at the second optical coupling interface 350-2. At this point, the external optical waveguide cable 800 can be optically connected to the first ferrule 250-1 of the laser module 200, i.e., at the first optical coupling interface 350-1.

The process of inserting (plugging) the laser module 200 into the receptacle 720 also results in the back-end section 217 of the PCB 200 being received by the slot 318 of the O-E adapter 300. This results in the upper and lower electrical contacts 322 and 324 that reside within the slot 318 making electrical contact with corresponding electrical features 220 (e.g., PCB electrical contacts) on the back-end section 217 of the PCB 210 at the electrical coupling interface 352. The upper and lower wires 323 and 325 make contact with the corresponding electrical features (electrical contacts) 520 supported by the main PCB 500 (see FIG. 2C), thereby establishing electrical communication between the main PCB 500 and the laser module 200 via the electrical coupling interface 352. This electrical communication can be used to provide electrical power to the laser unit 230. as well as provide low-frequency control interface signals to the laser unit, as well as to the ASICS 600.

The control signals from the main PCB 500 cause the lasers 54 of the laser unit 230 to emit respective light beams 56. In this regard, consider by way of example the sub-set of lasers 54-1 through 54-4 shown in FIG. 4A, which respectively emit laser light beams 56-1 through 56-4 having respective wavelengths λ1 through λ4. The laser light beams 56-1 through 56-4 are directed to the corresponding multiplexer 30M, which multiplexes the laser light beams and sends them over one of the second optical waveguides 270-2 and then to one of the optical waveguides 270-3 of the harness 260-3 at the second optical coupling interface 350-2.

Meanwhile, the external or “receive” optical signals RX from the external cable 800 are optically coupled to the first optical waveguides 270-1 at the first optical coupling interface 350-1 and then optically coupled into the third optical waveguides 270-3 of the harness 260-3 at the second optical coupling interface 350-2. The receive optical signals RX are then directed to the O-E device 620, which receives and processes these receive optical signals (e.g., demultiplexes them and then converts them into electrical signals). In the example shown in FIG. 4A, the O-E device 620 includes a first demultiplexer 30D-1 and optical receivers 40R, which are electrically connected to a switching unit 630. The O-E device 620 also includes optical modulators 650, i.e., 650-1 through 650-4 shown by way of example. Each optical modulator 640 has an input end 652 and an output end 654.

Meantime, the multiplexed laser light beams 56-1 through 56-4 are also received by the O-E device 620, which further includes a second demultiplexer 30D-2 and a multiplexer 30M. The second demultiplexer 30D-2 is optically coupled to the input ends 652 of the optical modulators 650-1 through 650-4. The output ends 654 of the optical modulators 650-1 through 650-4 are optically coupled to the multiplexer 30M. The multiplexer 30M in turn is optically coupled to select third optical waveguides 270-3 of the harness at the third optical interface 350-3. The select first optical waveguides 270-1 of the laser module 200 are optically coupled to corresponding cable optical waveguides 270-C of the cable 800 at the first optical coupling interface 350-1.

With particular reference now to FIG. 4A, the laser light beams 56-1 through 56-4 received by the O-E processor 620 are directed from the second demultiplexer 30D-2 to the respective optical modulators 650-1 through 650-4. The modulators 650-1 through 650-4 respectively modulate the laser light beams 56-1 through 56-4 to create corresponding “transmit” optical signals TX1 through TX4. These transmit optical signals TX1 through TX4 are sent to the multiplexer 30M of the O-E device 620. This multiplexer 30M multiplexes the transmit optical signals TX1 through TX4 onto one of the optical waveguides 270-3 of the harness 260-3. The transmit optical signals TX1 through TX4 travel over the harness 260-3 and are optical coupled into one of the first optical waveguides 270-1 of the laser module 200 at the second optical coupling interface 350-2. The transmit optical signals TX1 through TX4 then travel over the optical waveguide 270-1 and are optically coupled into one of the “transmit” cable optical waveguides 270-C of the cable 800 at the first optical coupling interface 350-1.

To summarize, the unmodulated laser light beams 56 are sent in a first direction through the second optical coupling interface 350-2 and provided to the O-E device 620, which uses these unmodulated light beams to generate the transmit optical signals TX that are then sent in a second direction through the second optical coupling interface and to the “transmit” optical waveguides 270-C of the cable 800.

FIG. 4B shows the two systems 100 (100A, 100B) of FIG. 4A optically connected by the cable 800 to form a CWDM system 900. FIG. 4C is similar to FIG. 4B and shows an example CWDM system 900 that includes multiple systems 100.

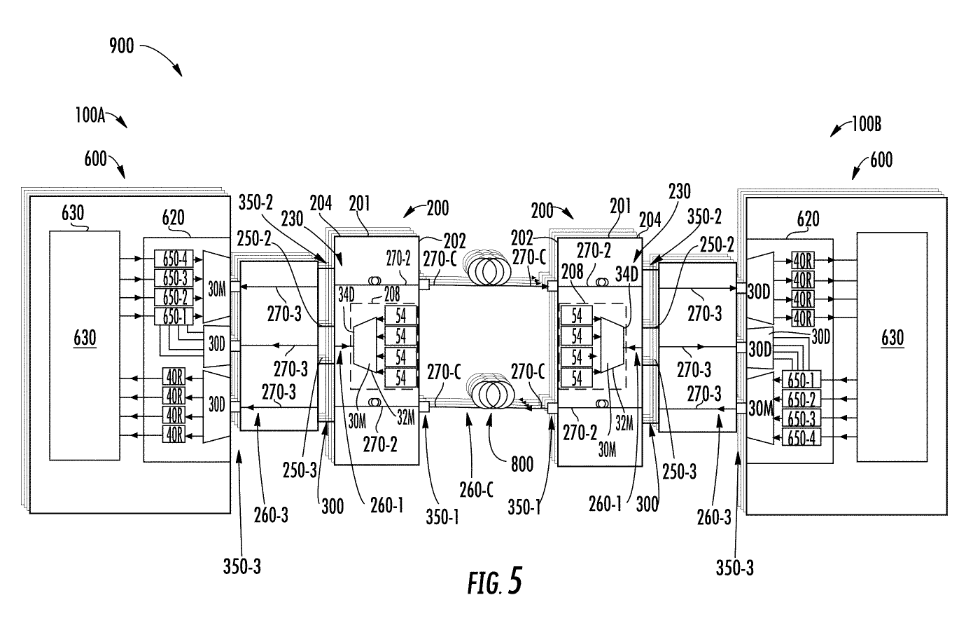

FIG. 5 is a schematic diagram illustrating how multiple laser modules 200 can be used to establish multiple O-E communication links 910 with the switching channels of the ASIC 600. In the example of FIG. 5, the ASICS 600 supports 256 channels and each of the 16 communication links 910 supports 16 channels via 16 optical waveguides. In an example configuration, 16 cables 800 each carrying 16 cable optical waveguides 270-C are used to carry the receive and transmit optical signals RX and TX.

Advantages

The laser modules 200 and the systems 100 disclosed herein have a number of advantages. The first advantage relates to reliability management. The lasers 54 are the most critical components in many if not most laser-based telecommunications systems. A typical failure in time (FIT) rate for a DFB laser can be in the range of 10 to 20 at 40° C. At higher temperatures, the FIT rate increases greatly. For example, an example system 10 operating at 25.6 Tbps with a 50G modulation per carrier requires 512 laser 54. The resulting FIT based on the lasers 54 only will be 512·10 (@40° C.)=5120 FIT. This number is expected to be 4× greater in prior art configurations where the lasers are located close to the ASIC 600 and can have a much higher temperature, e.g., 80° C. The proposed architecture for system 10 addresses the reliability issue by allowing easy replacement failed lasers 54.

A related advantage is ease of maintenance. If a problem with one of the lasers 54 is detected, the laser module 200 can easily be removed from the front plate 710 replaced by a new one. This saves time and costs as compared to a complete shutdown and removal of the entire system from the rack and sending it out for repair.

Another advantage is thermal management. The lasers 54 in the laser assembly 208 benefit from a lower temperature by providing higher optical output power plus an increased lifetime. In addition, the power dissipation of the lasers 54 and optional laser cooling do not need to be handled by the ASIC 600 (e.g., by the thermal heat spreader) and thus can be designed for each laser module 200 independently.

An additional advantage is application functionality. The choice of laser 54 determines the reach and the standard the optical link can achieve. For example, some lasers do not need to be cooled to provide sufficient carrier quality for 2 km optical links, whereas a cooled laser might be needed for a 10 km optical link. Disaggregating the lasers from the main PCB board of the system and keeping them remote from the ASIC provides more application flexibility.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A laser module for plugging into and unplugging from a receptacle in an optical telecommunications switching apparatus, comprising:
a module housing comprising a first end, a second end and an interior;
a first ferrule supported at the first end of the module housing and a second ferrule supported at the second end of the module housing;
first optical waveguides that reside in the module housing interior and that optically connect the first ferrule to the second ferrule;
a laser assembly that resides at least partially disposed within the interior of the module housing and that emits laser light beams comprising a plurality of different wavelengths; and
second optical waveguides that reside in the module housing interior and that optically connect the laser assembly to the second ferrule.

2. The laser module according to claim 1, wherein the first and second optical waveguides comprise optical fibers.

3. The laser module according to claim 1, wherein the laser assembly comprises:
a first circuit board; and
a laser unit operably supported by the first circuit board, the laser unit comprising a plurality of lasers that generate the laser light beams, and at least one multiplexer having an input end optically coupled to the plurality of lasers and an output end optically coupled to the second optical waveguides.

4. The laser module according to claim 3, wherein each of the plurality of lasers comprises a distributed feedback laser.

5. The laser module according to claim 3, wherein the first circuit board includes a first-end section with a first end and a second-end section with a second end, wherein the first-end section resides within the module housing interior and the second-end section extends from the second end of the module housing and comprises first electrical features.

6. The laser module according to claim 5, further comprising:
a second circuit board comprising second electrical features; and
an optical-electrical (O-E) adapter supported by the second circuit board and configured for receiving the first ferrule and configured for receiving the second-end section of the first circuit board, wherein the O-E adapter comprises third electrical features configured for providing electrical communication between the first electrical features of the first circuit board and the second electrical features of the second circuit board when the second-end section of the first circuit board is received by the O-E adapter.

7. The laser module according to claim 6, further comprising:
an optical-electrical (O-E) device and an application-specific integrated circuit (ASIC) supported by the second circuit board; and
third optical waveguides having first ends supported by a third ferrule that is received by the O-E adapter for providing optical communication between the third optical waveguides and the first and second optical waveguides and wherein the third optical waveguides comprise second ends that are in optical communication with the O-E device.

8. The laser module according to claim 6, wherein the O-E device is incorporated with the ASIC.

9. The laser module according to claim 7, further comprising an optical waveguide cable that supports transmit and receive optical waveguides and that is optically coupled to the first ferrule.

10. A laser module for a laser module system, comprising:
a first circuit board comprising a first-end section with a first end, a second-end section with a second end, and first and second opposite sides, wherein at least the second-end section comprises electrical features;
a laser unit operably supported at the first-end section of the first circuit board, the laser unit comprising a plurality of lasers optically coupled to at least one multiplexer, with the plurality of lasers configured for emitting respective laser beams comprising a plurality of different wavelengths;
a first optical waveguide harness comprising first optical waveguides comprising first ends supported by a first ferrule operably disposed adjacent the first end of the first circuit board and second ends supported by a second ferrule adjacent the second end of the first circuit board; and
a second optical waveguide harness comprising second optical waveguides comprising first ends optically coupled to the at least one multiplexer of the laser unit and second ends operably supported by the second ferrule.

11. The laser module according to claim 10, further comprising a module housing comprising a first end, an opposite second end and an interior, wherein the first ferrule is supported at the first end of the module housing and defines a first optical coupling interface, the second ferrule is supported at the second end of the module housing, and the back-end section of the first circuit board extends from the second end of the module housing.

12. The laser module according to claim 10, further comprising:
a third harness comprising third optical waveguides comprising first ends operably supported by a third ferrule and second ends operably supported by a fourth ferrule;
a second circuit board comprising a first-end section with a first end, a second-end section with a second end and second electrical features; and
an optical-electrical (O-E) adapter supported by the second circuit board and configured for receiving the first ferrule and configured for receiving the second-end section of the first circuit board, wherein the O-E adapter comprises third electrical features configured for providing electrical communication between the first electrical features of the first circuit board and the second electrical features of the second circuit board when the second-end section of the first circuit board is received by the O-E adapter.

13. The laser module according to claim 12, further comprising:
an application specific integrated circuit (ASIC) operably supported by and electrically coupled to the second circuit board at the second-end section; and
an optical-to-electrical (O-E) device that is operably connected to the ASIC, wherein the fourth ferrule is optically coupled to the O-E device.

14. The laser module according to claim 13, wherein the O-E device comprises a plurality of optical modulators each comprising an input end and an output end, at least one demultiplexer optically coupled to the input ends of the optical modulators, and at least one multiplexer optically coupled to the output ends of the optical modulators.

15. The laser module according to claim 10, further comprising an optical waveguide cable comprising transmit and receive optical waveguides optically coupled to the first optical waveguides of the first optical waveguide harness at the first optical coupling interface.

16. The laser module according to claim 11, wherein the module housing fits within a receptacle of an optical telecommunications switching apparatus.

17. The laser module according to claim 10, wherein the first and second optical waveguides comprise first and second optical fibers.

18. A pluggable laser module for plugging into and unplugging from a receptacle of an optical telecommunications switching apparatus, comprising:
a module housing having first and second opposite ends and an interior and sized to fit within the receptacle;
a first circuit board comprising a first-end section with a first and, a second-end section with a second end, wherein the first-end section is disposed within the interior of the module housing and wherein the second-end section comprises first electrical features and extends from the second end of the module housing;
a laser unit operably supported on the first-end section of the first circuit board and comprising a plurality of lasers that respectively emit laser light beams comprising a plurality of different wavelengths, and at least one multiplexer comprising an input end and an output end, with the input end optically coupled to the plurality of lasers;
first optical fibers comprising first ends supported by a first ferrule at the first end of the module housing and comprising second ends supported at the second end of the module housing by a second ferrule;
second optical fibers comprising first ends optically coupled to the multiplexer of the laser assembly and comprising second ends supported by the second ferrule at the second optical coupling interface; and
a second circuit board comprising a first-end section with a first end, a second-end section with a second end and second electrical features, wherein modular housing is supported by the second-end section of the second circuit board.

19. The pluggable laser module according to claim 18, further comprising:
an optical-to-electrical (O-E) adapter supported by the second circuit board and configured for receiving the second ferrule and comprising a slot for receiving the back-end section of the first circuit board, the O-E adapter comprising third electrical features that place the first and second electrical features of the first and second circuit boards in electrical communication when the second-end section of the first circuit board is operably engaged in the slot of the O-E adapter.

20. The pluggable laser module according to claim 19, further comprising third optical fibers comprising first ends supported by a third ferrule and second ends supported by a fourth ferrule, wherein the third ferrule is received by the O-E adapter to define an optical interface between the second and third ferrules for establishing optical communication between the third optical fibers supported by the third ferrule and the first and second optical fibers supported by the second ferrule.

21. The pluggable laser module according to claim 20, further comprising:
an O-E device; and
an application specific integrated circuit (ASIC) in operable communication with the O-E device; and
wherein the second ends of the third optical fibers are optically coupled to the O-E device via the fourth ferrule, and wherein the O-E device and the ASIC are operably supported at the second-end section of the second PCB.

22. The pluggable laser module according to claim 21, wherein the O-E device comprises a plurality of optical modulators each comprising an input end and an output end, at least one demultiplexer optically coupled to the input ends of the optical modulators, and at least one multiplexer optically coupled to the output ends of the optical modulators.

23. The pluggable laser module according to claim 18, further comprising an optical waveguide cable comprising transmit and receive optical waveguides optically coupled to the first optical waveguides of the first optical waveguide harness at the first optical coupling interface.

24. A laser module system for use with an optical telecommunications switching apparatus comprising a receptacle with an interior having an interior end, comprising:
a laser module comprising: i) first and second ferrules; ii) a first harness defined by first optical waveguides that optically connect the first ferrule to the second ferrule; iii) a laser assembly configured for generating laser light beams comprising a plurality of different wavelengths; and iv) a second harness defined by second optical waveguides that optically connect the laser assembly to the second ferrule;
a third harness defined by third optical waveguides terminated by third and fourth ferrules, the third harness residing within the optical telecommunications switching apparatus; and
an optical-electrical (O-E) adapter that resides within the optical telecommunications switching apparatus at the interior end of the receptacle and configured for receiving the second and third ferrules and place the first and second optical waveguides of the first and second harnesses in optical communication with the third optical waveguides of the third harness.

25. The laser module system according to claim 24, wherein the laser module comprises a module housing configured for operably plugging into and unplugging from the receptacle.

26. The laser module system according to claim 25, wherein the laser module housing has an interior, and wherein the laser assembly, the first harness and the second harness are disposed within the interior.

27. The laser module system according claim 26, wherein the first ferrule is supported at a first end of the module housing and the second ferrule is supported at a second end of the module housing, and wherein the O-E adapter is disposed adjacent the second end of the module housing.

28. The laser module system according to claim 24, further comprising:
an application-specific integrated circuit (ASIC) and an optical-electrical (O-E) device, wherein the O-E device is in operable communication with the ASIC, and wherein the ASIC and the O-E device are disposed within the optical telecommunications switching apparatus; and
wherein the third harness is optically connected to the O-E device.

29. The laser module system according to claim 28, wherein the laser assembly comprises a laser unit operably mounted to a first circuit board, wherein the laser assembly is operably supported by a second circuit board, and further comprising an electrical coupling interface configured for allowing electrical power and electrical control signals to be communicated from the second circuit board to the laser unit.

30. The laser module system according to claim 24, wherein the first, second and third waveguides respectively comprise first, second and third optical fibers.

31. A method of forming multiplexed optical signals, comprising:
generating unmodulated laser light beams having different wavelengths using lasers that are disposed in an interior of a module housing comprising first and second ends, with the first end defining a first optical coupling interface;
transmitting the unmodulated laser light beams to an O-E device in a first direction through a second optical coupling interface defined by an O-E adapter, wherein the O-E adapter and the O-E device is disposed outside of the module housing;
using the O-E device, forming optical signals from the unmodulated laser light beams, wherein the optical signals respectively comprise the different wavelengths; and
sending the optical signals from the O-E device to the first optical coupling interface by passing the optical signals through the second optical coupling interface in a second direction opposite the first direction and through the interior of the module housing.

32. The method according to claim 31, wherein the transmitting of the unmodulated laser light comprises multiplexing the unmodulated laser light beams onto one of first optical waveguides on a first side of the second optical interface and then coupling the multiplexed and unmodulated laser light beams into one of second optical waveguides on a second side of the second optical interface.

33. The method according to claim 31, wherein the sending the optical signals from the O-E device comprises multiplexing the optical signals onto another one of the second optical waveguides on the second side of the second optical interface and coupling the multiplexed optical signals into one of third optical waveguides on the first side of the second optical interface, wherein the third optical waveguides pass through the interior of the module housing.

34. The method according to claim 33, wherein each of the first, second and third optical waveguides comprise first, second and third optical fibers.

35. The method according to claim 31, wherein the second end of the module housing comprises a ferrule that at least in part defines the second optical interface, and wherein generation and transmitting of the unmodulated laser light beams comprises multiplexing the unmodulated laser light beams onto one of first optical waveguides having first and second ends, with the second ends supported by the ferrule.

36. The method according to claim 35, wherein the ferrule can be inserted into and removed from the O-E adapter.

37. The method according to claim 31, wherein the optical signals define transmit optical signals and further comprising receiving at the first optical interface receive optical signals and sending the receive optical signals from the first optical interface and through the interior of the module housing and through the second optical interface in the first direction to the O-E device.

38. The method according to claim 31, wherein the unmodulated laser light beams are generated by a plurality of distributed-feedback lasers.
